(19) United States
(12) Patent Application Publication
(10) Pub. No.: US 2008/0093494 A1
(43) Pub. Date: Apr. 24, 2008

(54) Seat belt retractor and seat belt apparatus employing the same

(75) Inventor: Yoshihiro KAWAMURA, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 11/905,013

(22) Filed: Sep. 27, 2007

(30) Foreign Application Priority Data
Oct. 20, 2006 (JP) 2006-285982

(51) Int. Cl. B60R 22/34

(52) U.S. Cl. 242/372

(57) ABSTRACT

A seat belt retractor includes a spool for winding a seat belt, a spring device for always biasing the spool in the belt winding direction, and a locking device which allows rotation of the spool when it is not activated and locks the spool from rotating in the seat belt withdrawing direction when it is activated. The spring device has a first spring always acting on the spool to bias the spool in the seat belt winding direction, and a second spring capable of acting on the spool to bias the spool in the seat belt winding direction. The seat belt retractor has a clutch for switching a mode of the second spring between an effective mode and an ineffective mode. The seat belt retractor further includes a control device which changes the winding torque during the seat belt winding operation.

### BACKGROUND OF THE INVENTION AND RELATED ART STATEMENT

The present invention relates to a seat belt retractor and a seat belt apparatus employing the same which is installed in a vehicle such as an automobile and is adapted to restrain an occupant with a seat belt thereof, wherein the seat belt retractor has a function of preventing an occurrence of end lock and at least an emergency locking function.

Conventionally, seat belt apparatuses are installed in vehicles such as automobiles. In the event of an emergency such as a vehicle collision where a large deceleration acts on the vehicle, such a seat belt apparatus restrains an occupant with a seat belt thereof so as to prevent the occupant from jumping out of the seat.

FIG. 7 is an illustration schematically showing an example of such seat belt apparatuses with conventional seat belt retractors.

As shown in FIG. 7, a seat belt apparatus 1 of this example comprises a seat belt retractor 3 fixed to a vehicle body such as a B pillar 2, a seat belt 6 which can be withdrawn from the seat belt retractor 3 and is provided at its tip end with a belt anchor 4 fixed to a vehicle floor or a vehicle seat 5, a deflective fitting 7 which is fixed to a vehicle body such as a center pillar to guide the seat belt 6 withdrawn from the seat belt retractor 3 to a shoulder of an occupant C, a tongue 8 which is slidably attached to the seat belt 6 guided by the deflective fitting 7, and a buckle 9 which is fixed to the vehicle floor or the vehicle seat and to which the tongue 8 can be detachably latched.

In the seat belt apparatus 1, the occupant C wears the seat belt 6 by withdrawing the seat belt 6 from the seat belt retractor 3 and latching the tongue 8 attached to the seat belt 6 to the buckle 9.

Generally, the seat belt apparatus is provided with a seat belt retractor. As the seat belt retractor, a seat belt retractor having a function as an emergency locking type seat belt retractor (ELR) capable of locking the seat belt from withdrawn has been known (see, for example, Patent document 1: JP-A-2001-058559).

FIG. 8 is a vertical sectional view showing an example of the seat belt retractor disclosed in Patent document 1. In this drawing, a numeral 10 designates a spool for winding up the seat belt 6, a numeral 11 designates a U-like frame, a numeral 12 designates a deceleration sensing device (vehicle sensor) which senses a large vehicle deceleration, generated at an emergency as mentioned above, and thus activates, a numeral 13 designates a locking device which is activated by the deceleration sensing device 12 to lock at least the spool 10 from rotating in the seat belt withdrawing direction, a numeral 14 designates a torsion bar which is fitted and inserted into the center of the spool 10 in the axial direction and connects the spool 10 and the locking device 13 to be rotated together, a numeral 15 designates a spring device which always biases the spool 10 in the seat belt winding direction via a bush 17 by a spiral spring 16, a numeral 18 designates a pretensioner which is activated when extremely large vehicle deceleration is generated among the aforementioned emergency situations to produce a seat belt winding torque, and a numeral 19 designates a bush for transmitting the seat belt winding torque of the pretensioner 18 to the spool 10.

The locking device 13 is provided with a locking base (corresponding to a locking member of the present invention) 22 which can rotate together with a first torque transmitting shaft 20 of the torsion bar 14 and holds a pawl 21 pivotally. The locking device 13 is also provided with a lock gear 13a which normally rotates together with the torsion bar 14 but, in an emergency, stops by the operation of the deceleration sensing device 12 to produce a rotational difference relative to the torsion bar 14 so that the pawl 21 is engaged with internal teeth 23 formed in a side wall of a frame 11 to lock the locking base 22 from rotating in the seat belt withdrawing direction. The locking base 22 is provided with an external threaded shaft portion 24 on which a nut-like stopper member 25 rotating together with the spool 10 is screwed.

The torsion bar 14 is provided with a second torque transmitting portion 26 which is engaged with the spool 10 not to allow the relative rotation therebetween.

By the spring force of the spring device 15, the spool 10 is always biased in the seat belt winding direction via the bush 17, the torsion bar 14, the second torque transmitting portion 26 of the torsion bar 14, and the bush 19. In addition, during the operation of the pretensioner 18, the seat belt winding torque produced by the pretensioner 18 is transmitted to the spool 10 via the bush 19, whereby the spool 10 winds up a predetermined amount of the seat belt 6.

In the conventional seat belt retractor 3 having the aforementioned structure, the seat belt 6 is wound up by the biasing force of the spring device 15 completely (fully) when the seat belt is not worn. As the seat belt 6 is withdrawn at a normal speed from this state, the spool 10 rotates in the seat belt withdrawing direction, thereby withdrawing the seat belt 6. After the tongue 8 slidably attached to the seat belt 6 is inserted into and latched to the buckle 9 fixed to the vehicle body, an excessively withdrawn part of the seat belt is wound onto the spool 10 by the biasing force of the spring device 15.

In an emergency as mentioned above, the deceleration sensing device 12 senses a large vehicle deceleration and then activates the locking device 13. That is, by the activation of the deceleration sensing device 12, the lock gear 13a is locked from rotating in the seat belt withdrawing direction so that the pawl 21 of the locking device 13 pivots to engage the internal teeth 23 formed in the side wall of the frame 11. Then, the locking base 22 is locked from rotating in the seat belt withdrawing direction so that the torsion bar 14 is twisted so as to allow only rotation of the spool 10 relative to the locking base 22 in the seat belt withdrawing direction. After this, the spool 10 rotates in the seat belt withdrawing direction while twisting the torsion bar 14. According to the torsion torque of the torsion bar 14, the load applied to the seat belt 6 is limited, thereby absorbing energy applied to the occupant.

Also as for the conventional seat belt retractor 3, when the seat belt is rapidly withdrawn, the rotation of the lock gear 13a is stopped by an inertia member (webbing sensor) (not shown) supported by the lock gear 13a. Accordingly, the locking base 22 of the locking device 13 rotates in the seat belt withdrawing direction relative to the rock gear 13a. Therefore, the pawl 21 of the locking device 13 engages the internal teeth 23 formed in the side wall of the frame 11 in the same manner as mentioned above so as to lock the locking base 22 from rotating, thereby locking the spool 10 from rotating in the belt withdrawing direction via the torsion bar 14 and thus locking the seat belt from being withdrawn.

After the occupant C withdraws the seat belt 6, inserts and engages the tongue 8 into the buckle 9 when sitting in a vehicle seat, an excessively withdrawn part of the seat belt 6 is wound so as to achieve normal wearing state. In this normal wearing state, it is preferable not to give undesired oppression on a chest of the occupant C. However, since, generally in the seat belt retractor 3, the spool 10 is always biased in the seat belt winding direction with the winding torque of the spring device 15, the occupant C may feel oppression when normally wearing the seat belt. To avoid this, it may be considered to employ a spring 16 with weak biasing force for reducing the oppression against the occupant. However, the spring 16 with weak biasing force provides small winding torque for winding up the seat belt so that the seat belt 6 is hardly wound up completely (fully) when the occupant C cancels the wearing of the seat belt 6.

For this, it has been known that a seat belt retractor is provided with an ELR function and also a tension reducer for reducing the biasing force of a spring device for winding up a seat belt while an occupant wears the seat belt under the normal wearing condition (for example, see Patent document 2: JP-B-7-008639).

The tension reducer disclosed in Patent document 2 is provided to a spring device for biasing a spool in the seat belt winding direction. That is, the tension reducer employs a main spring and a sub spring which are arranged in parallel in the spring device. The total spring force of the main spring and the sub spring is set to be substantially the same as the spring force of a case employing one spring in the spring device. Therefore, each of the spring forces of the main spring and the sub spring is set to be smaller than the spring force of the case employing one spring in the spring device.

As shown in FIG. 9, in the tension reducer, the spool is biased in the seat belt winding direction with a relatively large winding torque by both the spring force of the main spring and the spring force of the sub spring during the seat belt withdrawing operation, while a winding torque only by the spring force of the main spring acts on the spool at the completion of the seat belt wearing operation by the occupant C. Accordingly, when the occupant C wears the seat belt, the winding torque on the spool is relatively small so as to lower the tension on the seat belt. Therefore, the seat belt is lightly pulled only by the main spring so as to lightly fit the occupant C.

As the occupant C disengages the tongue from the buckle and releases the tongue for cancelling the wearing of the seat belt, the spool winds up the seat belt completely (fully) by the relatively large torque of the total spring forces of the main spring and the sub spring. During this winding action, the winding torque is constant.

By the way, in the general seat belt retractor having the ELR function, the rotation of the spool 10 is rapidly stopped at the completion of seat belt winding by the spring force of the spring device 15 when cancelling the wearing of the seat belt 6. Accordingly, a phenomenon may occur in which at least one of the vehicle sensor 12 and a webbing sensor is activated due to impact of the rapid stoppage of the spool 10 so that the seat belt 6 is hardly withdrawn next time. This phenomenon is called “end lock”.

For preventing the end lock, it may be considered to employ a spring 16 with weak biasing force for winding up the seat belt. However, if employing the spring with weak biasing force, the seat belt is hardly wound up completely (fully) as mentioned above.

The present invention has been made under the aforementioned circumstances, and an object of the present invention is to provide a low-cost seat belt retractor and a seat belt apparatus comprising the same which can wind up a seat belt completely when an occupant cancels the wearing of the seat belt and still can prevent the end lock.

Further objects and advantages of the invention will be apparent from the following description of the invention.

### SUMMARY OF THE INVENTION

To solve the aforementioned problems, a seat belt retractor according to the invention of a first aspect comprises at least: a spool for winding up a seat belt; a spring device for always biasing said spool in the belt winding direction; and a locking device which allows rotation of said spool when it is not activated and locks said spool from rotating in the seat belt withdrawing direction when it is activated, wherein said spring device has a first spring with a spring force always acting on said spool to bias said spool in the seat belt winding direction, and a second spring with a spring force capable of acting on said spool to bias said spool in the seat belt winding direction. The seat belt retractor is provided with a clutch for switching the mode of said second spring between an effective mode where its spring force acts on said spool and an ineffective mode where its spring force does not act on said spool. The seat belt retractor further comprises a control device which changes the winding torque during the seat belt winding operation after the occupant cancels the wearing of the seat belt by controlling said clutch so as to switch the mode of said second spring between the effective mode and the ineffective mode.

As to a seat belt retractor according to a second aspect of the invention, said winding torque is changed by controlling said clutch to make only the spring force of said first spring to act on said spool and, after a lapse of time, make both the spring forces of said first and second springs to act on said spool.

As to a seat belt retractor according to a third aspect of the invention, said winding torque is changed by controlling said clutch to make both the spring forces of said first and second springs to act on said spool and, after a lapse of time, make only the spring force of said first spring to act on said spool.

A seat belt retractor according to a fourth aspect of the invention comprises at least: a spool for winding up a seat belt; a spring device for always biasing said spool in the belt winding direction; and a locking device which allows rotation of said spool when it is not activated and locks said spool from rotating in the seat belt withdrawing direction when it is activated, wherein said spring device has a first spring with a spring force capable of acting on said spool to bias said spool in the seat belt winding direction, and a second spring with a spring force smaller than that of the first spring and capable of acting on said spool to bias said spool in the seat belt winding direction. The seat belt retractor is provided with a clutch for switching the respective modes of said first and second springs between an effective mode where the spring force acts on said spool and an ineffective mode where the spring force does not act on said spool, and said seat belt retractor further comprises a control device which changes the winding torque during the seat belt winding operation after the occupant cancels the wearing of the seat belt by controlling said clutch so as to switch the respective modes of said first and second springs between the effective mode and the ineffective mode.

As to a seat belt retractor according to a fifth aspect of the invention, said first and second springs and said clutch cooperate together to compose a tension reducer for reducing the tension on the seat belt during the wearing of the seat belt, and said control device controls said clutch to make the spring force of said second spring not to act on said spool when the occupant completes the wearing of the seat belt.

A seat belt apparatus according to a sixth aspect of the invention comprises at least: a seat belt for restraining an occupant; a seat belt retractor which winds up the seat belt and allows the seat belt to be withdrawn; a tongue slidably attached to said seat belt; and a buckle to which said tongue can be detachably latched, wherein said seat belt retractor is a seat belt retractor in any one of the aforementioned seat belt retractors of the present invention.

According to the seat belt retractor and the seat belt apparatus of the present invention having the aforementioned structure, the clutch is controlled to switch the respective modes of the first and second springs between an effective mode where its spring force acts on said spool and an ineffective mode where its spring force does not act on said spool, thereby changing the winding torque during the seat belt winding operation. This enables the winding speed during the seat belt winding operation to be changed. Accordingly, the winding torque or the winding speed at the completion of the seat belt winding operation can be changed to a suitable value, thereby reducing the impact generated by the stop of the rotation of the spool at the completion of the seat belt winding operation. Therefore, the occurrence of end lock at the completion of the seat belt winding operation is effectively prevented by a simple structure.

Since the winding torque or the winding speed at the completion of the seat belt winding operation can be adjusted to be suitable value, the winding torque and the winding speed before the completion of the seat belt winding operation can be set to such a value as to wind up the seat belt completely (fully). Therefore, the end lock can be prevented while the seat belt is still enabled to be wound up completely when the seat belt is not worn.

Especially, the end lock can be prevented by a low cost structure using components of the conventional known tension reducer such as the two springs, the clutch, and the electromagnetic solenoid.

### BRIEF DESCRIPTION OF THE DRAWINGS

FIG. 1 is an illustration schematically showing an embodiment of a seat belt retractor according to the present invention.

FIGS. 2(a)-2(c) are illustrations for explaining the actions of a tension reducer of the embodiment shown in FIG. 1.

FIG. 3 is a flow chart showing a flow for controlling the winding torque to be changed.

FIG. 4 is an illustration for explaining the winding torque during the seat belt withdrawing operation and the seat belt winding operation of the seat belt retractor according to the flow shown in FIG. 3.

FIG. 5 is a flow chart similar to FIG. 3 but showing a flow of another embodiment of the seat belt retractor of the present invention.

FIG. 6 is an illustration for explaining the winding torque during the seat belt withdrawing operation and the seat belt winding operation of the seat belt retractor of the embodiment shown in FIG. 5.

FIG. 7 is an illustration schematically showing an example of a seat belt apparatus with a conventional seat belt retractor.

FIG. 8 is a vertical sectional view showing an example of a seat belt retractor disclosed in Patent document 1.

FIG. 9 is an illustration for explaining the winding torque during the seat belt withdrawing operation and the seat belt winding operation of the conventional seat belt retractor.

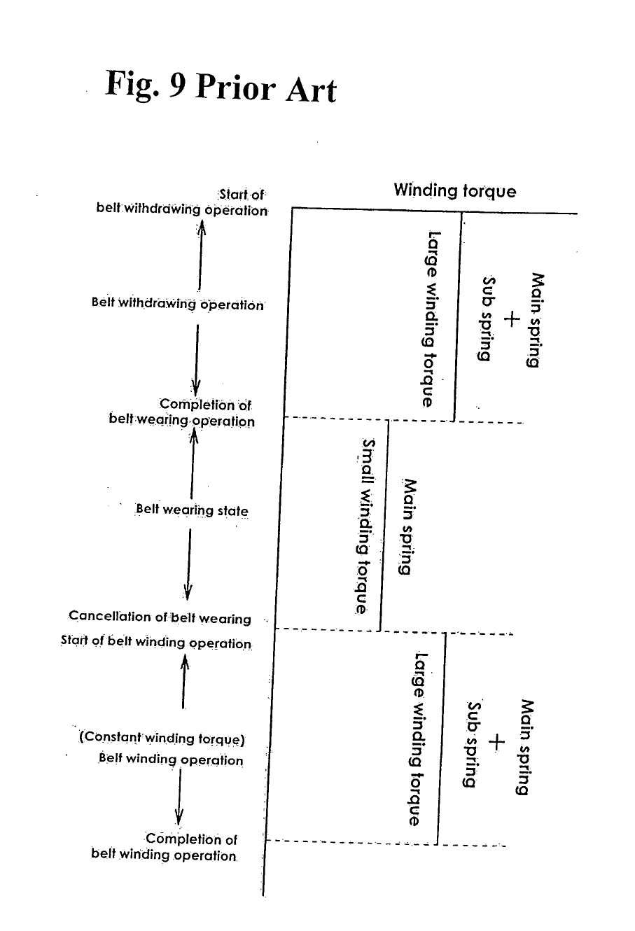

### DETAILED DESCRIPTION OF PREFERRED EMBODIMENTS

Hereinafter, best modes for carrying out the present invention will be described with reference to the attached drawings.

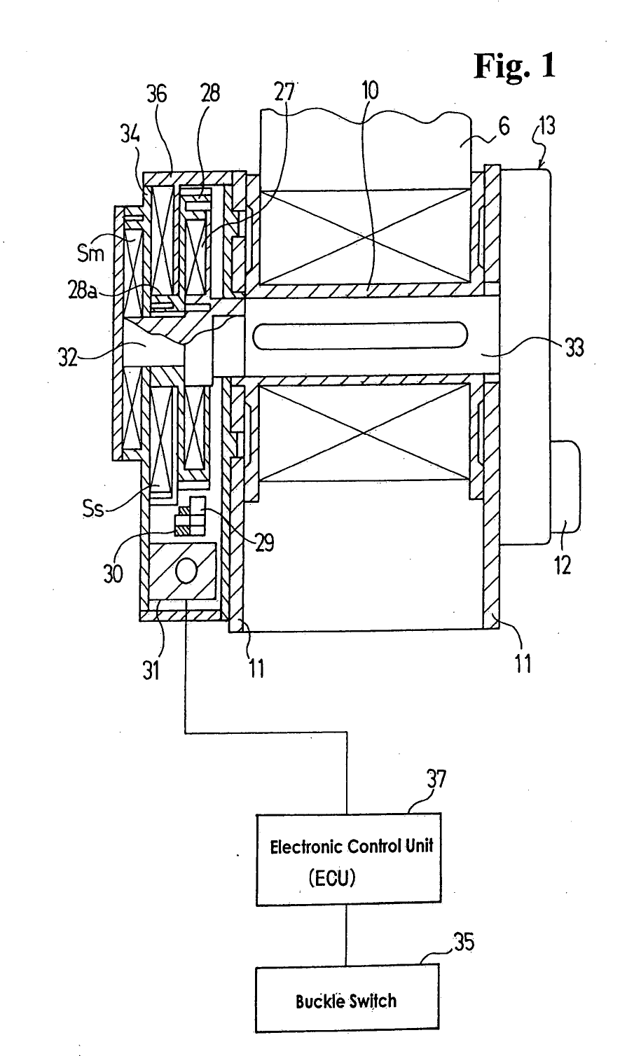

FIG. 1 is a sectional view schematically showing an embodiment of a seat belt retractor according to the present invention. It should be noted that the same components of the aforementioned seat belt apparatus and the aforementioned seat belt retractor will be marked with the same numerals so as to omit the detail description.

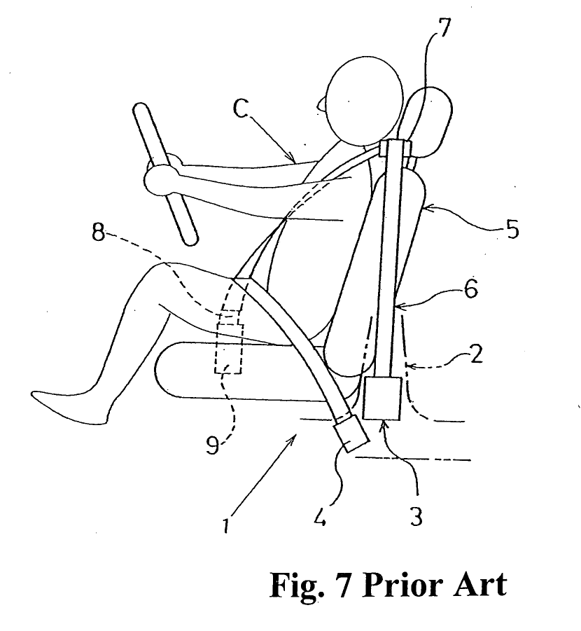

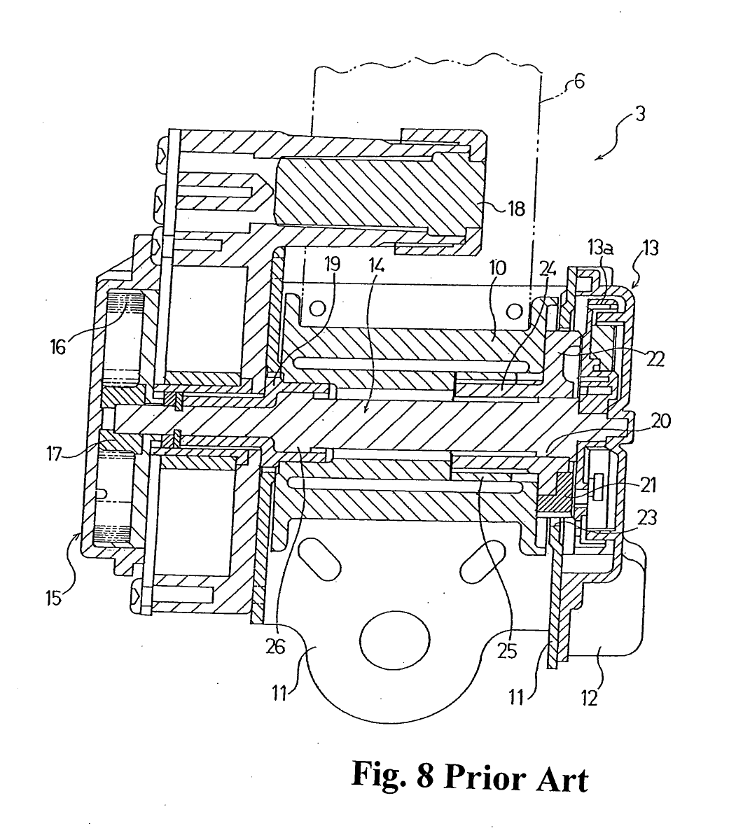

The seat belt retractor 3 of this embodiment comprises a locking device 13 which is the same as the locking device 13 of the aforementioned seat belt retractor disclosed in Patent document 1 shown in FIG. 8. Further, the seat belt retractor 3 of this embodiment comprises a tension reducer which is the same as the tension reducer of the aforementioned seat belt retractor disclosed in Patent document 2. Furthermore, the seat belt retractor 3 of this embodiment is employed in a seat belt apparatus 1 which is the same as the seat belt apparatus 1 shown in FIG. 7.

In FIG. 1, a mark “Sm” designates a main spring (corresponding to the first spring of the present invention), as one of springs in the spring device 15, for always biasing the spool 10 in the winding direction, a mark “Ss” designates a sub spring (corresponding to the second spring of the present invention), also as one of the springs for giving biasing force in the winding direction to the spool 10 intermittently. A numeral 27 designates a tape which is disposed in a clutch gear 28 with a boss 28a connected to one end of the sub spring Ss and is wound in a spiral shape to connect the main spring Sm and the sub spring Ss, a numeral 29 is a clutch pawl, a numeral 30 designates a pivot lever which is pivotally supported by a frame 11 and has the clutch pawl 29, a numeral 31 designates an electromagnetic solenoid for driving the pivot lever to pivot, a numeral 32 is a connecting shaft, a numeral 33 designates a main shaft, a numeral 34 designates a spring housing, a numeral 35 designates a buckle switch for detecting the latching of the tongue 8 with the buckle 9, and a numeral 36 designates a cover. It should be noted that the seat belt retractor 3 of this embodiment has no torsion bar 7 (shown in FIG. 8) and has the simple main shaft 33. The main shaft 33 is connected to the spool 10 to rotate together with the spool 10 and is connected to the locking base 22 of the locking device 13 to allow rotation relative to the locking base 22.

The main spring Sm and the sub spring Ss are arranged in parallel in a plane perpendicular to the axial direction of the spool 10. The main spring Sm always biases the spool 10, on which the seat belt 6 is wound, in the seat belt winding direction via the connecting shaft 32 and the main shaft 33. The inner end of the main spring Sm is connected to an end portion of the connecting shaft 32 and the outer end of the main spring Sm is connected to a portion of the inner surface of the spring housing 34.

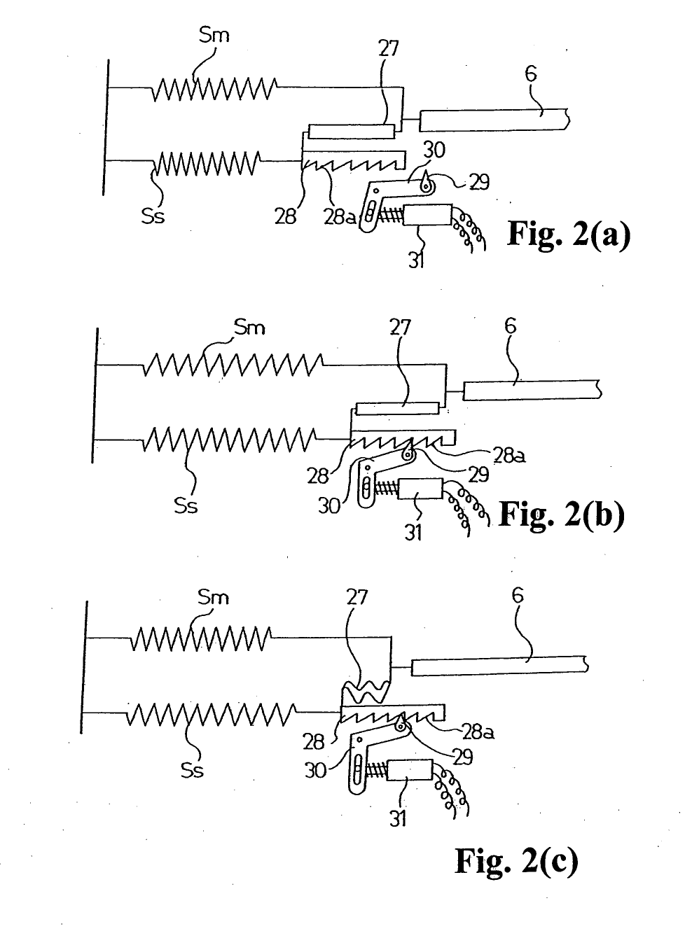

On the other hand, the inner end of the sub spring Ss is fixed to the boss 28a formed integrally with the clutch gear 28 having ratchet teeth. The clutch pawl 29 is disposed to prevent the clutch gear 28 from return-moving in a direction toward the non-operational position of the clutch gear 28 (leftward in FIG. 2). The prevention of the return-movement of the clutch gear 28 by the clutch pawl 29 can be cancelled by the pivot lever 30 and the electromagnetic solenoid 31.

The tape 27 for memory is disposed between the main spring Sm and the sub spring.

FIGS. 2(a)-2(c) are illustrations for explaining the operation of the seat belt retractor, wherein FIG. 2(a) is an illustration showing the non-operational state of the seat belt retractor, FIG. 2(b) is an illustration showing a state where the seat belt is withdrawn from the seat belt retractor for wearing the seat belt, and FIG. 2(c) is an illustration showing the normally wearing state of the seat belt after latching the tongue with the buckle.

When the seat belt retractor is in the non-operational state as shown in FIG. 2(a), the main spring Sm and the sub spring Ss are compressed to the maximum so that the tape 27 is in the tensioned state. In this state, the seat belt 6 is wound completely. In addition, the clutch pawl 29 is set in its non-operational position where the clutch pawl 29 can engage the clutch gear 28 in the seat belt winding direction.

As the seat belt 6 is withdrawn from the seat belt retractor 3 (rightward in FIG. 2(a)) from the non-operational state of the seat belt retractor 3, the clutch gear 28 and the tape 27 move rightward together with the seat belt 6 as shown in FIG. 2(b) (rotate in the seat belt withdrawing direction). Then, both the main spring Sm and the sub spring Ss expand, and the clutch pawl 29 engages the clutch gear 28 to prevent the movement in the belt winding direction, thereby preventing the return movement of the clutch gear 28.

As the occupant C wears the seat belt 6 by latching the tongue 8 with the buckle 9, the seat belt 6 excessively withdrawn is slightly wound leftward in FIG. 2(b). Since the return movement of the clutch gear 28 is prevented, only the main spring Sm compresses so that the tape 27 sags as shown in FIG. 2(c). Accordingly, the seat belt 6 is not biased by the sub spring Ss and is biased only by the main spring Sm. Therefore, in the normally wearing state in which an excessively withdrawn part of the seat belt 6 is wound after the tongue is latched with the buckle, the seat belt 6 is pulled lightly only by the main spring Sm as shown in FIG. 2(c) so that the seat belt 6 lightly fits the occupant C.

In the normally wearing state of the seat belt 6 as shown in FIG. 2(c), as the electromagnetic solenoid 31 is excited by rotating the pivot lever 30 in the clockwise direction so as to release the clutch pawl 29 from the clutch gear 28, the clutch gear 28 is allowed to move (rotate) leftward in FIG. 2(c) so that the clutch gear 28 moves (rotates) rapidly in a direction of winding (direction of tensioning) the tape 27 by the biasing force of the sub spring Ss. As the tape 27 is tensioned, the seat belt 6 is biased by both the main spring Sm and the sub spring Ss so that the seat belt 6 is strongly wound onto the spool 10. That is, the tape 27 is structured as a memory device for storing the rotating amount of the spool 10 relative to the clutch gear 28.

As the winding of the seat belt 6 onto the spool 10 is completed, the electromagnetic solenoid 31 is not excited, the pivot lever 30 rotates in the counter-clockwise direction so that the clutch pawl 29 becomes the non-operational position shown in FIG. 2(a) where the clutch pawl 29 can engage the clutch gear 28. In addition, the seat belt 6, the main spring Sm, the sub spring Ss, and the tape 27 become their non-operational states shown in FIG. 2(a).

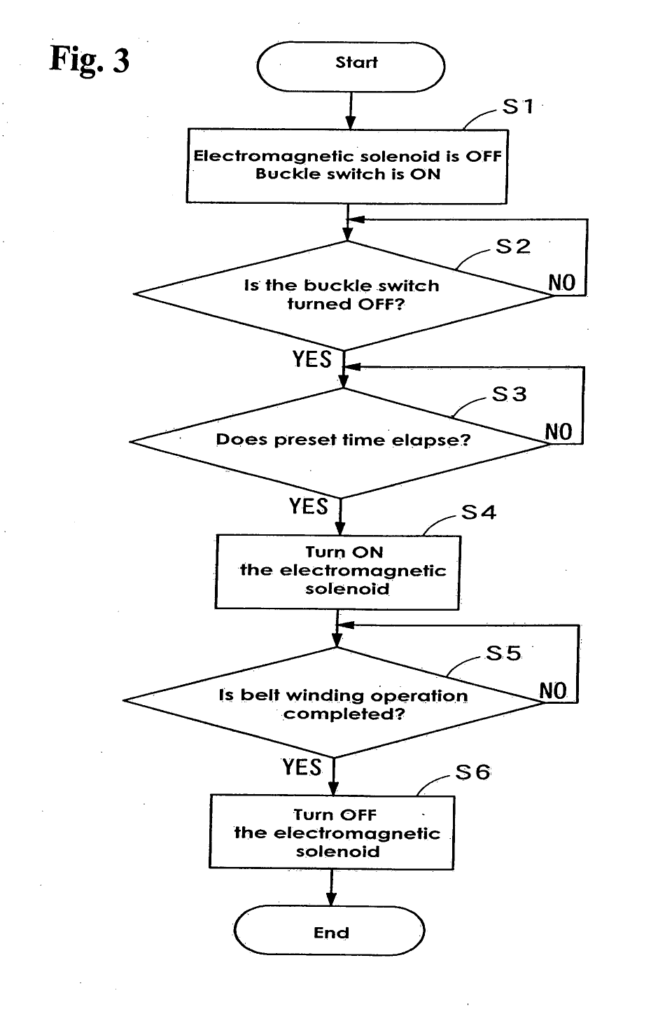

The electromagnetic solenoid 31 is connected to an electronic control unit (ECU) 37 (corresponding to the control device of the present invention) and is thus controlled by the ECU. In this case, the ECU 37 controls the electromagnetic solenoid 31 according to a control flow shown in FIG. 3.

That is, in step S1, the electromagnetic solenoid 31 is in the OFF state and the buckle switch 35 is in the ON state because the seat belt is worn as shown in FIG. 3. Because of the OFF state of the electromagnetic solenoid 31, the clutch pawl 29 engages the clutch gear 28 to prevent the movement in the seat belt winding direction. In step S2, it is determined whether or not the buckle switch 35 is turned OFF. That is, it is determined whether or not the tongue 8 is released from the buckle 9. When the buckle switch 35 is in the ON state, the tongue 8 is latched with the buckle 8. When the buckle witch 35 is in the OFF state, the tongue 8 is released from the buckle 9. Until it is determined that the buckle switch 35 is turned OFF, the process of the step S2 is repeated. During this operation, the tongue 8 is latched with the buckle 9 so that the seat belt 6 is worn by the occupant C.

If it is determined that the buckle switch 35 is turned OFF in step S2, it is determined whether or not the time elapsing from the OFF of the buckle switch 35 reaches a preset time. The preset time is set to be smaller than a time elapsing from “buckle release” to “completion of belt winding”. The “buckle release” means that the buckle switch 35 is turned OFF, i.e. the tongue 8 is released from the buckle 9, and the “completion of belt winding” means that the spool 10 winds up the seat belt 6 completely, i.e. the seat belt winding operation is completed.

As the tongue 8 is released from the buckle 9 so that the buckle switch 35 is turned OFF, spool 10 starts to wind up the seat belt. At this point, the clutch pawl 29 of the tension reducer engages the clutch gear 28 to prevent the movement in the seat belt winding direction so that the seat belt 6 is wound up by the spool 10 with only the spring force of the main spring Sm. That is, the winding torque of the spool 10 is relatively small. Until it is determined that the time elapsing from the OFF of the buckle switch 35 reaches the preset time, the process of the step S3 is repeated. In this case, the winding torque of the spool 10 is kept at a small torque by the main spring Sm.

If it is determined that the time elapsing from the OFF of the buckle switch 35 reaches a preset time, the electromagnetic solenoid 31 is turned ON in step S4. Accordingly, the pivot lever 30 pivots to release the clutch pawl 29 from the clutch gear 28. Then, the seat belt 6 is wound up by the spool 10 with the total of the spring force of the main spring Sm and the spring force of the sub spring Ss. That is, the winding torque of the spool 10 is relatively large because of the total of the spring force of the main spring Sm and the spring force of the sub spring Ss.

Then, in step S5, it is determined whether or not the seat belt winding operation is completed. Until it is determined that the seat belt winding operation is completed, the process of the step S5 is repeated. At this point, the seat belt winding operation is conducted with the large winding torque by the total of the spring force of the main spring Sm and the spring force of the sub spring Ss.

If it is determined that the seat belt winding operation is completed in step S5, the electromagnetic solenoid 31 is finally turned OFF in step S6.

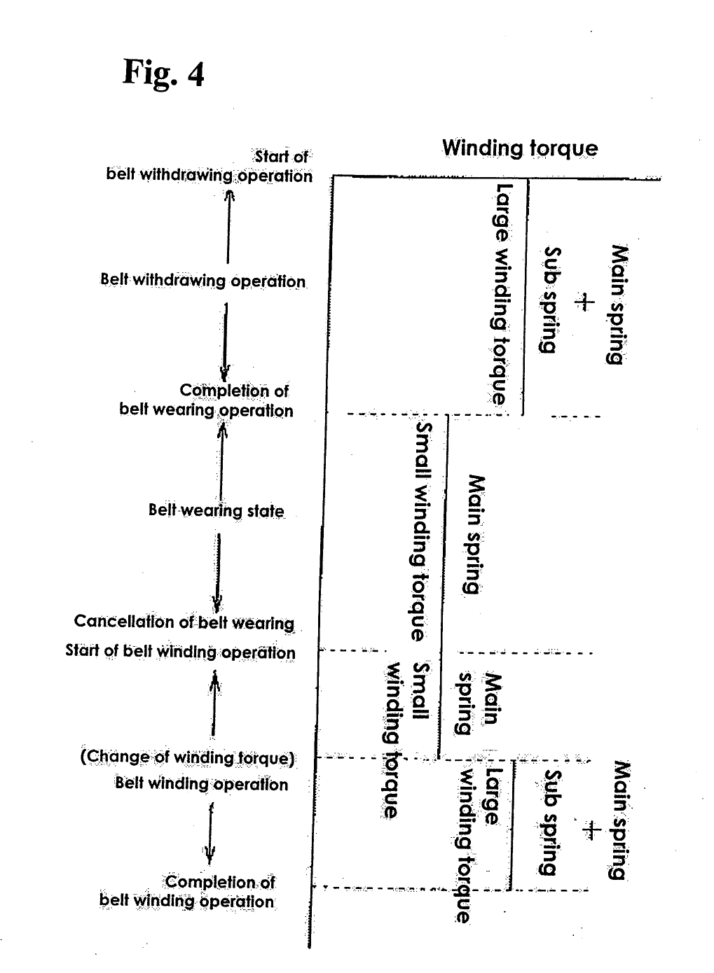

As shown in FIG. 4, in the tension reducer in the seat belt retractor 3 of this embodiment similarly to the conventional tension reducer as mentioned above, the spool is biased in the seat belt winding direction with a relatively large winding torque by both the spring force of the main spring Sm and the spring force of the sub spring Ss during the seat belt withdrawing operation, while a winding torque only by the spring force of the main spring acts on the spool at the completion of the seat belt wearing operation by the occupant C. Accordingly, when the occupant C wears the seat belt, the winding torque on the spool is relatively small so as to lower the tension on the seat belt. Therefore, the seat belt is lightly pulled only by the main spring so as to lightly fit the occupant C.

As the occupant C disengages the tongue 8 from the buckle 9 and takes his hand off the tongue 8 or the seat belt 6 in order to cancel the wearing of the seat belt, the spool 10 first winds up the seat belt 6 with the relatively small torque only by the spring force of the main spring Sm. As the preset time elapses from the disengagement of the tongue 8 from the buckle 9, the spool 10 winds up the seat belt 6 completely (fully) with the relatively large torque by the total of the spring force of the main spring Sm and the spring force of the sub spring Ss. In this manner, the winding torque at the start of the winding operation is set to be small torque, and the winding torque after a lapse of the preset time is set to be large torque. Therefore, at the completion of the winding of the seat belt 6, the seat belt winding speed is low so that the impact generated by the stop of the rotation of the spool 10 is reduced. Therefore, the occurrence of end lock at the completion of the winding of the seat belt 6 is prevented.

According to the seat belt retractor 3 and the seat belt apparatus 1 of this embodiment, the winding torque is changed such that the winding torque at the start of the seat belt winding operation just after the occupant cancels the wearing of the seat belt is set to be small and the winding torque after a lapse of the preset time is set to be large, whereby the seat belt winding speed can be set to be low at the completion of the winding of the seat belt 6 as compared to the conventional seat belt winding with a constant large winding torque. Therefore, the impact generated by the stop of the rotation of the spool 10 is reduced, thereby effectively preventing the occurrence of end lock at the completion of the winding of the seat belt 6 by a simple structure.

Further, since the seat belt 6 is wound up with the large winding torque by the total spring force of the main spring Sm and the sub spring Ss and at a relatively high winding speed, the seat belt 6 can be wound up completely (fully).

In this manner, the end lock can be prevented while the seat belt 6 still can be wound up completely when the occupant cancels the wearing of the seat belt.

Especially, a low-cost structure for preventing the end lock is achieved by using components of the conventional tension reducer such as the two springs Sm, Ss, the clutch 29, the electromagnetic solenoid 31.

Since the other components and the other works and effects of the seat belt retractor 3 of this embodiment are the same as those of the seat belt retractor disclosed in the aforementioned Patent document 2, the detailed description about those will be omitted.

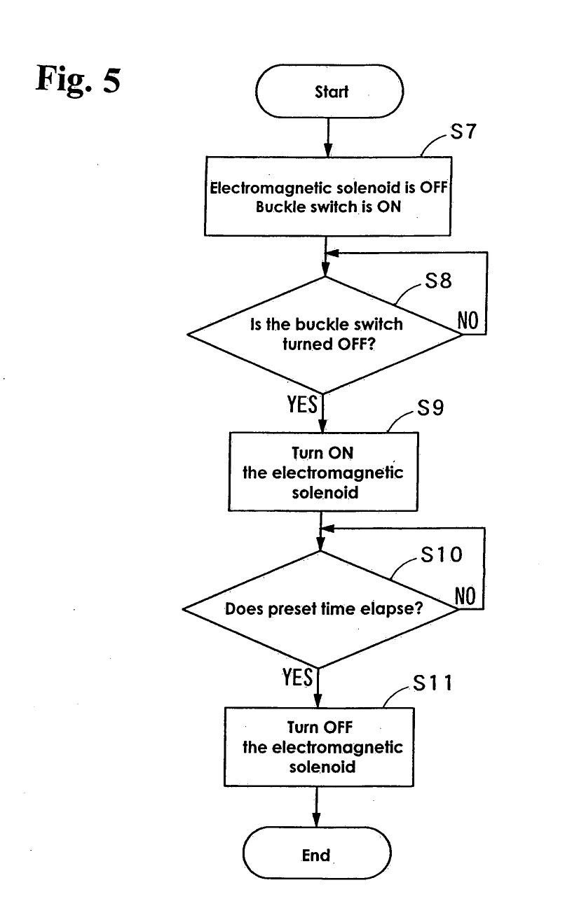

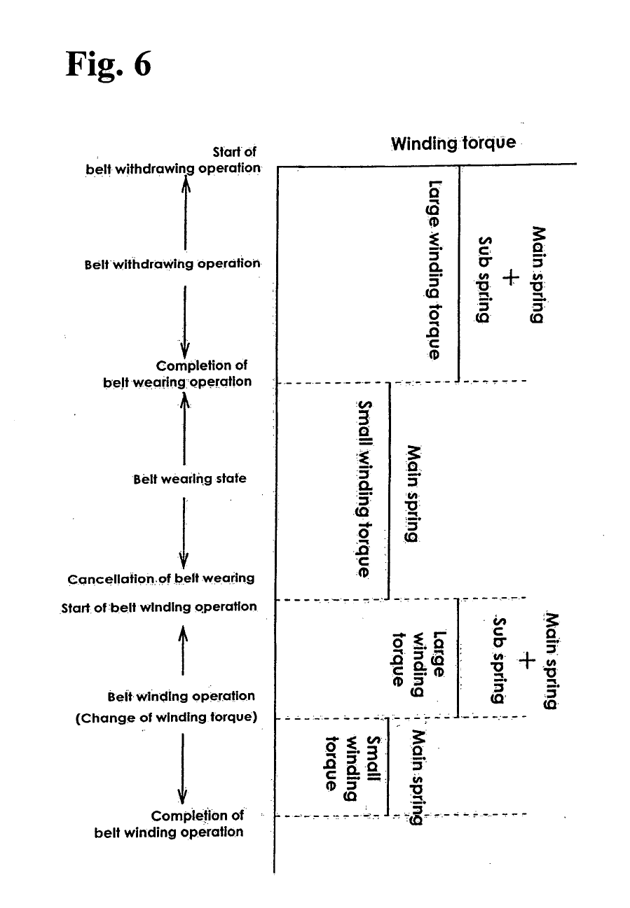

FIG. 5 is a flow chart similar to FIG. 3 but showing another embodiment of the seat belt retractor of the present invention and FIG. 6 is an illustration for explaining the winding torque during the seat belt withdrawing operation and the seat belt winding operation of the seat belt retractor of this embodiment.

Though the winding torque at the start of the seat belt winding operation is set to be a small winding torque and the winding torque after that is set to be a large winding torque in the aforementioned embodiment, the winding torque at the start of the seat belt winding operation is set to be a large winding torque and the winding torque after that is set to be a small winding torque in the seat belt retractor 3 of this embodiment.

That is, as shown in FIG. 5, in step S7 and step S8, the same processes in step S1 and step S2 of the aforementioned embodiment are conducted. Then, if it is determined that the buckle switch 35 is turned OFF in step S8, the electromagnetic solenoid 31 is turned ON in step S9. As the tongue 8 is released from the buckle 9 so that the buckle switch 35 is turned OFF, spool 10 starts to wind up the seat belt. In addition, the pivot lever 30 pivots so as to disengage the clutch pawl 28 from the clutch gear 28 so that the seat belt 6 is wound up by the spool 10 with the total of the spring force of the main spring Sm and the spring force of the sub spring Ss. That is, the winding torque of the spool 10 is relatively large because of the total of the spring force of the main spring Sm and the spring force of the sub spring Ss.

Then, in step S10, it is determined whether or not the time elapsing from the OFF of the buckle switch 35 reaches a preset time (which is different from the preset time of the aforementioned embodiment). The preset time is set to be shorter than a time elapsing from “buckle release” to “completion of belt winding”. The “buckle release” means that the buckle switch 35 is turned OFF, i.e. the tongue 8 is released from the buckle 9, and the “completion of belt winding” means that the spool 10 winds up the seat belt 6 completely, i.e. the seat belt winding operation is completed.

Until it is determined that the time elapsing from the OFF of the buckle switch 35 reaches the preset time, the process of the step S10 is repeated. In this case, the winding torque of the spool 10 is kept at a large torque by both the main spring Sm and the sub spring Ss.

If, in step S10, it is determined that the time elapsing from the OFF of the buckle switch 35 reaches a preset time, the electromagnetic solenoid 31 is turned OFF in step S11. Accordingly, the pivot lever 30 pivots by the spring force of the electromagnetic solenoid 31 so that the clutch pawl 29 engages the clutch gear 28. By this engagement, the winding torque of the spool 10 is changed to be relatively small because of only the spring force of the main spring Sm. That is, the seat belt 6 is wound up by the spool 10 with the small winding torque through to completion. Therefore, the seat belt winding speed is low at completion of the seat belt winding operation so that the impact at the stop of the rotation of the spool 10 is small, thereby preventing the occurrence of end lock at the completion of the seat belt winding operation.

According to the seat belt retractor 3 and the seat belt apparatus 1 of this embodiment, the winding torque is changed such that the winding torque at the start of the seat belt winding operation just after the occupant cancels the wearing of the seat belt is set to be large and the winding torque after a lapse of the preset time is set to be small as shown in FIG. 6, whereby the seat belt winding speed can be set to be low at the completion of the winding of the seat belt 6 as compared to the conventional seat belt winding with a constant large winding torque. Therefore, the impact generated by the stop of the rotation of the spool 10 is reduced, thereby effectively preventing the occurrence of end lock at the completion of the winding of the seat belt 6 by a simple structure.

Further, the seat belt 6 is wound up with the large winding torque by the total spring forces of the main spring Sm and the sub spring Ss and at a relatively high winding speed during the preset time after the start of the seat belt winding operation. Though the winding speed just before the completion of the seat belt winding operation of this case is low as compared to the conventional winding speed by the large constant winding torque because of the small winding torque, the winding speed is kept to be not lower than a certain speed so as to wind up the seat belt 6 completely (fully).

The other components and the other works and effects of the seat belt retractor 3 of this embodiment are the same as those of the seat belt retractor of the aforementioned embodiment.

Though the present invention is applied to a seat belt retractor 3 having an ELR function with a tension reducer in any one of the aforementioned embodiments, i.e. the present invention is achieved by using components of the tension reducer, the present invention is not limited thereto and can be applied to a seat belt retractor 3 having an ELR function without a tension reducer. In this case, the seat belt retractor comprises, instead of the main spring Sm and the sub spring Sm, a first spring capable of biasing the spool 10 in the seat belt winding direction and a second spring capable of biasing the spool 10 in the seat belt winding direction with a spring force smaller than that of the first spring and also comprises a spring device in which the first and second springs are arranged in parallel, a clutch for controlling the spring forces of the first and second springs to act or not to act on the spool 10 during the seat belt winding operation after the occupant cancels the wearing of the seat belt, and an electromagnetic solenoid for driving the clutch.

The seat belt retractor 3 and the seat belt apparatus employing the same of the present invention are suitably used as a seat belt retractor 3 which is provided with a tension reducer and a seat belt apparatus employing the same, wherein the tension reducer reduces the biasing force of a spring device for winding the seat belt while the seat belt is normally worn.

The disclosure of Japanese Patent Application No. 2006-285982 filed on Oct. 20, 2006 is incorporated as a reference.

While the invention has been explained with reference to the specific embodiments of the invention, the explanation is illustrative and the invention is limited only by the appended claims.

What is claimed is:

1. A seat belt retractor comprising:
a spool for winding a seat belt,
a spring device for always biasing said spool in a belt winding direction, said spring device having a first spring with a spring force always acting on said spool to bias said spool in the belt winding direction, and a second spring with a spring force capable of acting on said spool to bias said spool in the belt winding direction,
a locking device which allows rotation of said spool when it is not activated and locks said spool from rotating in the belt withdrawing direction when it is activated,
a clutch for switching a mode of said second spring between an effective mode where its spring force acts on said spool and an ineffective mode where its spring force does not act on said spool, and
a control device which changes a winding torque during a seat belt winding operation after the occupant cancels wearing of the seat belt by controlling said clutch to switch said second spring between the effective mode and the ineffective mode.

2. A seat belt retractor as claimed in claim 1, wherein said control device is arranged to change a winding torque by controlling said clutch to make only the spring force of said first spring to act on said spool and, after a lapse of time, make two spring forces of said first and second springs to act on said spool.

3. A seat belt retractor as claimed in claim 1, wherein said control device is arranged to change a winding torque by controlling said clutch to make two spring forces of said first and second springs to act on said spool and, after a lapse of time, make only the spring force of said first spring to act on said spool.

4. A seat belt retractor comprising at least:
a spool for winding a seat belt,
a spring device for always biasing said spool in a belt winding direction, said spring device having a first spring with a spring force capable of acting on said spool to bias said spool in the belt winding direction, and a second spring with a spring force smaller than that of the first spring and capable of acting on said spool to bias said spool in the belt winding direction,
a locking device which allows rotation of said spool when it is not activated and locks said spool from rotating in the belt withdrawing direction when it is activated,
a clutch for switching modes between an effective mode where the spring force acts on said spool and an ineffective mode where the spring force does not act on said spool, and
a control device which changes a winding torque during a seat belt winding operation after the occupant cancels wearing of the seat belt by controlling said clutch so as to switch the modes of said first and second springs between the effective mode and the ineffective mode.

5. A seat belt retractor as claimed in claim 1, wherein said first and second springs and said clutch compose a tension reducer for reducing tension on the seat belt during the wearing of the seat belt, and said control device controls said clutch to make the spring force of said second spring not to act on said spool when the occupant completes the wearing of the seat belt.

6. A seat belt apparatus comprising:
a seat belt for restraining an occupant,
said seat belt retractor according to claim 1, which winds the seat belt and allows the seat belt to be withdrawn,
a tongue slidably attached to said seat belt, and
a buckle to which said tongue can be detachably latched.

7. A seat belt retractor as claimed in claim 1, wherein said clutch includes a clutch gear connected to the second spring to control connection of the second spring to the spool, and a clutch pawl engageable with the clutch gear.

8. A seat belt retractor as claimed in claim 7, wherein said clutch further includes a tape situated between the first and second springs, and an actuation device for operating the clutch pawl.
